(19) United States
(12) Patent Application Publication
(10) Pub. No.: US 2009/0045041 A1
(43) Pub. Date: Feb. 19, 2009

(54) ELECTRONIC DEVICE AND POWER SWITCHING UNIT THEREOF

(75) Inventor: Kuo-Feng HUANG, Nantou County (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 12/172,167

(22) Filed: Jul. 11, 2008

(30) Foreign Application Priority Data
Aug. 15, 2007 (TW) TW96130137

(51) Int. Cl. H01H 3/40

(52) U.S. Cl. 200/501

(57) ABSTRACT

An electronic device and power switching unit thereof includes a shaft, a rotating member and a moving member. The rotating member, connected with the shaft, includes a first tooth portion and a second tooth portion. The moving member includes a rack an arm and a stopper. The rack interlocks with the first tooth portion. The shaft rotates the rotating member in a first direction, allowing the first tooth portion to separate from the rack, and the second tooth portion pushes the arm to rotate in a second direction. When the shaft rotates the rotating member in the second direction, the second tooth portion pushes the arm to rotate in the first direction toward the stopper, and the stopper limits the rotation of the arm, allowing the arm to move in a third direction.

This Application claims priority of Taiwan Patent Application No. 96130137, filed on Aug. 15, 2007, the entirety of which is incorporated by reference herein.

### BACKGROUND OF THE INVENTION

1. Field of the Invention

The invention relates to an electronic device and a power switching unit thereof, and in particular, to an electronic device utilizing an intermittent mechanism within the power switching unit to improve the collision problem between the gears and the rack.

2. Description of the Related Art

For a printer, power switching between the automatic document feeder and the printhead cleaning mechanism is achieved by gears in the power switching unit switching positions, allowing power output to the automatic document feeder or the printhead cleaning mechanism.

When the gears of the power switching unit are rotated to interlock with the gears of the automatic document feeder, the shaft rotates to actuate the automatic document feeder to introduce the document. When the gear of the power switching unit are rotated to interlock with the gears of the printhead cleaning mechanism, the shaft rotates to actuate the printhead cleaning mechanism to clean the printhead.

When power is shut down during the operation of the printhead cleaning mechanism, the printhead cleaning mechanism stops in an unpredictable position. After restarting the system, the power switching unit switches power to the printhead cleaning mechanism, and the printhead cleaning mechanism is moved to an initial position, such that the cleaning path of the printhead cleaning mechanism can be recalculated by the system.

However, the system is not able to calculate the distance between the initial position and unpredictable position where the printhead cleaning mechanism stopped. Therefore, the motor must be set to rotate by the system according to the maximum moving distance from the printhead cleaning mechanism to the initial position to assure the arrival of the printhead cleaning mechanism to the initial position.

Referring to FIG. 1, in a conventional printer 10, the gear 101 of the power switching unit interlocks with the rack 1021 of the printhead cleaning mechanism 102. The rotating shaft provides power to the gear 101, allowing the gear 101 to rotate and reciprocally moves the printhead cleaning mechanism 102. Thus, the correspondingly disposed printhead can be cleaned by the brush B provided on the printhead cleaning mechanism 102.

When the power is shut down and the system is restarted, if the motor continues to rotate after the printhead cleaning mechanism 102 has already been moved to the initial position, the shaft continuously rotates the gear 101 of the power switching unit, thereby causing collision of the gear and the rack, damaging the teeth thereon and producing noise.

### BRIEF SUMMARY OF THE INVENTION

The invention provides an electronic device and a power switching unit thereof comprising a shaft, a rotating member and a moving member. The rotating member, connected with the shaft, comprises a first tooth portion and a second tooth portion. The moving member comprises a rack, an arm and a stopper. The rack interlocks with the first tooth portion. The shaft rotates the rotating member in a first direction, allowing the first tooth portion to separate from the rack, and the second tooth portion pushes the arm to rotate in a second direction. When the shaft rotates the rotating member in the second direction, the second tooth portion pushes the arm to rotate in the first direction toward the stopper, and the stopper limits the rotation of the arm, allowing the arm to move in a third direction.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional electronic device;

FIG. 2A is a schematic view of an electronic device of the invention;

FIG. 2B is an elevational view of the electronic device in FIG. 2A; and

FIGS. 3A and 3B are schematic views of a rotating member and a moving member of the electronic device in FIG. 2B.

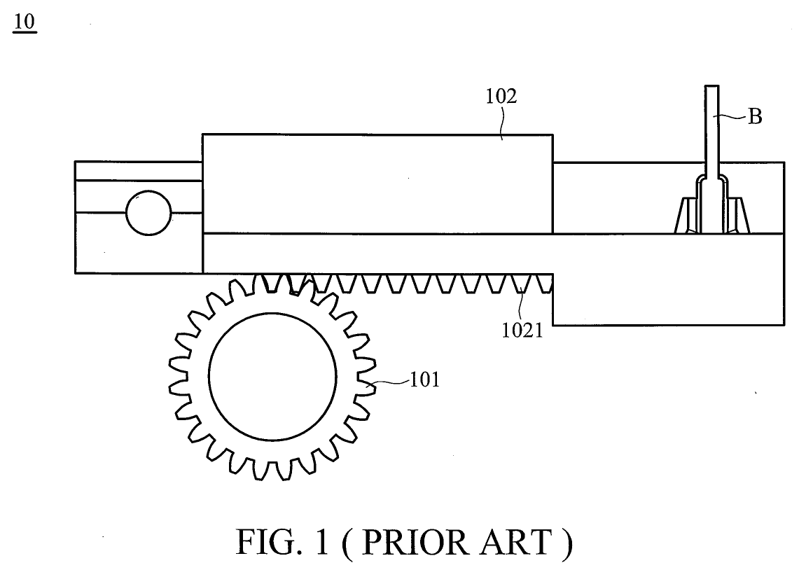

### DETAILED DESCRIPTION OF THE INVENTION

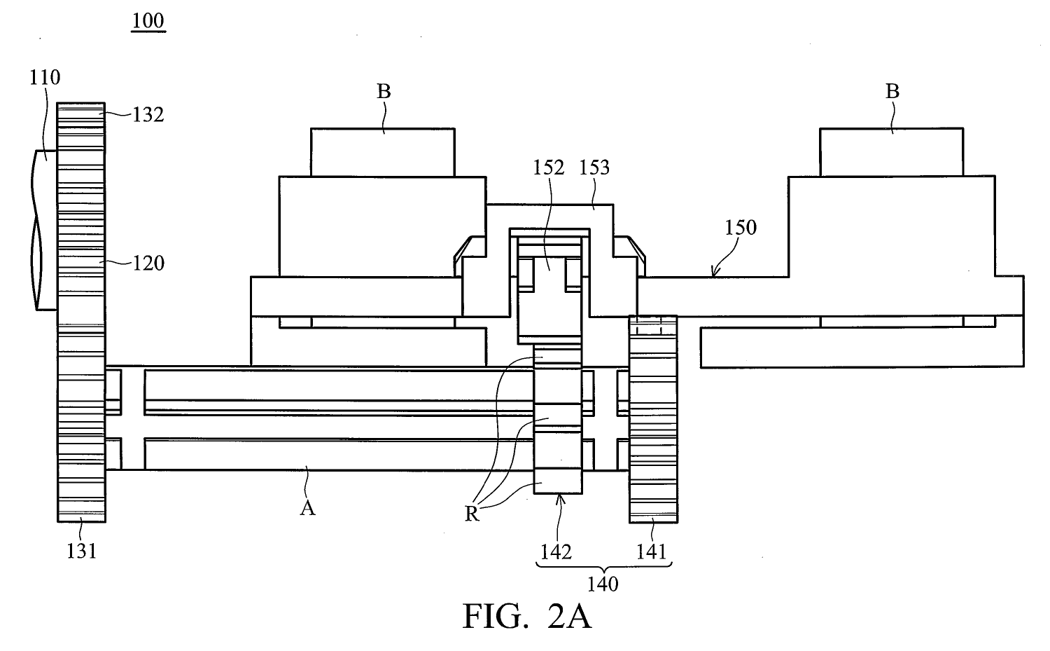

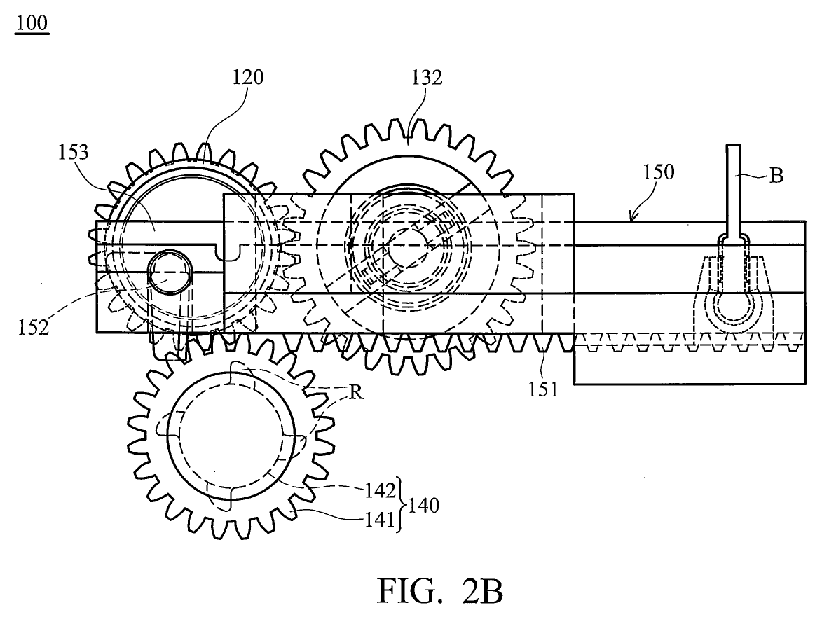

Referring to FIGS. 2A and 2B, the electronic device 100 of the invention is a printer, a fax machine or a multi-function printer. The electronic device 100 comprises an automatic document feeder, a printhead cleaning mechanism, a power switching unit and a power device.

The power switching unit comprises a shaft 110, a driving wheel 120, a first driven wheel 131 and a second driven wheel 132. The shaft 110 electrically connects with the power device for rotation by power. The shaft 110 connects with the driving wheel 120 to rotate the driving wheel 120. The first driven wheel 131 and the second driven wheel 132, respectively, interlocks with the driving wheel. If the position of the gear train is changed, the first driven is selectively switched to connect with the printhead cleaning mechanism (as shown in FIG. 2A), to output power thereto. Otherwise, the second driven wheel 132 is selectively switched to connect with the automatic document feeder (not shown), to output power thereto.

The power switching unit further comprises a rotating member 140, an intermediate shaft A and a moving member 150. The rotating member 140 comprises a first tooth portion 141 and a second tooth portion 142, wherein the second tooth portion comprises a plurality of ratches R. The rotating member 140 connects with the first driven 131 through the intermediate shaft A. In other words, the rotating member 140 indirectly connects with the shaft 110. Hence, when the first driven wheel 131 rotates, the rotating member 140 rotates along with the first driven wheel 131 in the same direction because the rotating member 140 coaxially connects with the first driven wheel 131.

It should be noted that in the embodiment, the first tooth portion 141 and the second tooth portion 142 of the rotating member 140 are individual gears. For example, the first tooth portion 141 is a pinion and the second tooth portion 142 is a ratchet.

The moving member 150 is a printhead cleaning mechanism in the embodiment, comprising a rack 151, an arm 152, a stopper 153 and a brush B. The arm 152 is rotatably disposed in a distance away from the rack 151, and the stopper 153 is disposed above the arm 152.

To clean the printhead, the first tooth portion 141 interlocks with the rack 151, and the brush B is correspondingly disposed below the printhead. The rotating member 140 rotates to reciprocally move the moving member 150, such that the brush B on the moving member 150 reciprocally moves under the printhead for cleaning.

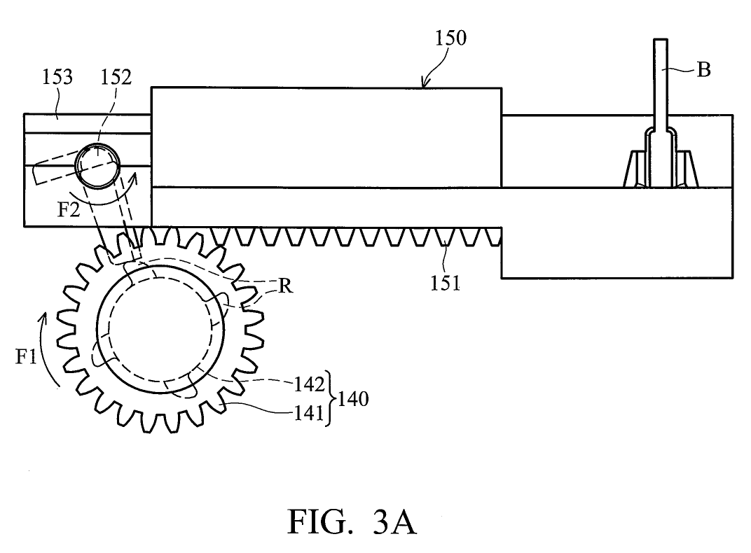

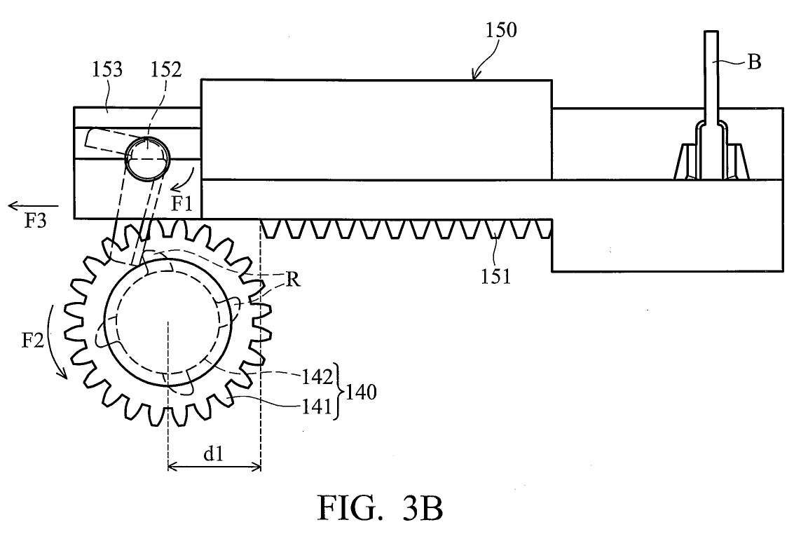

When the power is shut down, the rotating member 140 stop rotating, causing the moving member 150 to stop in a unpredictable position. When the system is restarted, the rotating member 140 rotates to move the moving member 150 to an initial position. Referring to FIG. 3A, the shaft 110 is actuated to rotate the rotating member 140 in a first direction F1 (clockwise) until the first tooth portion 141 of the rotating member 140 separates from the rack 151 of the moving member 150. Meanwhile, if the rotating member 140 keeps rotating after the moving member 150 has arrived in the initial position, the second tooth portion 142 of the rotating member 140 pushes arm 152 to rotate in a second direction F2 (counter-clockwise), with the moving member 150 not moved thereby.

Because the arm 152 freely rotates in the second direction F2, the arm 152 swivels after the ratches R of the second tooth portion 142 passing the arm 152 without affecting the moving member 150. In other words, the moving member 150 is not moved with the swivel of the arm 152.

As shown in FIG. 3B, to clean the printhead, the shaft 110 rotates the rotating member 140 in the second direction F2. During the rotation, the ratches R of the second tooth portion 142 push the arm 152 to rotate in the first direction F1 until abutting the stopper 153. The stopper 153 limits the rotation of the arm 152. Meanwhile, the rotating member 140 continuously rotates to move the arm 152 in a third direction F₃. The moving member 140 is moved along with the arm 152 in a distance d1, allowing the first tooth portion 141 to interlock with the rack 151 again.

When the rotating member of the electronic device returns to the initial position, the rotation of the rotating member does not cause a collision between the first tooth portion and the rack because the first tooth portion of the rotating member does not interlock with the rack. Therefore, the noise is eliminated and the teeth is kept undamaged. In addition, the design of the second tooth portion (ratchet) of the rotating member, and the disposition of the arm on the moving member are assembled to develop an intermittent system, bringing the first tooth portion and the rack back in interlocking position again for further cleaning of the printhead.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a shaft;
a rotating member connected to the shaft, comprising a first tooth portion and a second tooth portion; and
a moving member comprising a rack, an arm and a stopper, wherein the rack interlocks with the first tooth portion;
wherein when the shaft rotates the rotating member in a first direction, allowing the first tooth portion to separate from the rack, the second tooth portion pushes the arm to rotate in a second direction, and when the shaft rotates the rotating member in the second direction, the second tooth portion pushes the arm to rotate in the first direction toward the stopper, and the stopper limits the rotation of the arm, allowing the arm to move in a third direction.

2. The electronic device as claimed in claim 1, wherein the moving member moves a distance along with the arm in the third direction and the first tooth portion interlocks with the rack.

3. The electronic device as claimed in claim 1, wherein the second tooth portion comprises a plurality of ratches.

4. The electronic device as claimed in claim 1, wherein the moving member is a printhead cleaning mechanism.

5. The electronic device as claimed in claim 1, further comprising a power device connected electrically with the shaft.

6. The electronic device as claimed in claim 1, further comprising a driving wheel connected to the shaft.

7. The electronic device as claimed in claim 6, further comprising a first driven wheel selectively interlocked with the driving wheel, wherein the first driven wheel coaxially connects with the rotating member.

8. The electronic device as claimed in claim 7, further comprising a second driven wheel selectively interlocked with the driving wheel, wherein the second driven wheel connects with an automatic document feeder.

9. The electronic device as claimed in claim 7, further comprising an intermediate shaft connecting the first driven wheel and the rotating member.

10. A power switching unit, comprising:
a shaft;
a rotating member connected to the shaft, comprising a first tooth portion and a second tooth portion; and
a moving member comprising a rack, an arm and a stopper, wherein the rack interlocks with the first tooth portion;
wherein when the shaft rotates the rotating member in a first direction, allowing the first tooth portion to separate from the rack, the second tooth portion pushes the arm to rotate in a second direction, and when the shaft rotates the rotating member in the second direction, the second tooth portion pushes the arm to rotate in the first direction toward the stopper, and the stopper limits the rotation of the arm, allowing the arm to move in a third direction.

11. The power switching unit as claimed in claim 10, wherein the moving member moves a distance along with the arm in the third direction and the first tooth portion interlocks with the rack.

12. The power switching unit as claimed in claim 10, wherein the second tooth portion comprises a plurality of ratches.

13. The power switching unit as claimed in claim 10, further comprising a driving wheel connected to the shaft.

14. The power switching unit as claimed in claim 13, further comprising a first driven wheel selectively interlocked with the driving wheel, wherein the first driven wheel coaxially connects with the rotating member.

15. The power switching unit as claimed in claim 14, further comprising a second driven wheel selectively interlocked with the driving wheel, wherein the second driven wheel connects with an automatic document feeder.

16. The electronic device as claimed in claim 14, further comprising an intermediate shaft connecting the first driven wheel and the rotating member.
